(19) United States
(12) Patent Application Publication
(10) Pub. No.: US 2021/0056628 A1
(43) Pub. Date: Feb. 25, 2021

(54) METHOD, SYSTEM, AND NON-TRANSITORY COMPUTER-READABLE RECORD MEDIUM FOR CRYPTOCURRENCY OPTIMIZATION TRADING

(71) Applicant: LINE CORPORATION, Tokyo (JP)

(72) Inventors: Miyoung JANG, Seongnam-si (KR); Jaeman KIM, Seongnam-si (KR); Hyun Dong LEE, Seongnam-si (KR); Byung Jun HWANG, Seongnam-si (KR); Nara HWANG, Seongnam-si (KR); Dong Young HEO, Seongnam-si (KR); Byeong Guk GIM, Seongnam-si (KR)

(73) Assignee: LINE CORPORATION, Tokyo (JP)

(21) Appl. No.: 16/994,106

(22) Filed: Aug. 14, 2020

(30) Foreign Application Priority Data
Aug. 20, 2019 (KR) 10-2019-0102014

(51) Int. Cl. G06Q 40/04; G06Q 20/06; G06Q 20/38; G06Q 10/04; G06N 5/04

(52) U.S. Cl. CPC G06Q 40/04; G06Q 20/0655; G06Q 2220/00; G06Q 10/04; G06N 5/04; G06Q 20/381

(57) ABSTRACT

A method, system, and non-transitory computer-readable record medium for optimization trading of a cryptocurrency are provided. A method for optimization trading of a cryptocurrency includes calculating a volume of a target coin that is a cryptocurrency to be traded with a base coin corresponding to a cryptocurrency held by a user with respect to at least one market corresponding to a market cryptocurrency; and providing recommendation information related to trading of the target coin to an electronic device of the user based on the calculated volume of the target coin.

### CROSS-REFERENCE TO RELATED APPLICATION

This application claims priority to Korean Patent Application No. 10-2019-0102014, filed Aug. 20, 2019 in the Korean Intellectual Property Office, the disclosure of which is incorporated herein by reference in its entirety.

### BACKGROUND

### 1. Field

Apparatuses, systems, and methods according to example embodiments relate to automation technology for optimization trading (buy/sell) of a cryptocurrency.

### 2. Description of Related Art

Currently, with the advent of encryption technology, interest in a cryptocurrency based on encryption technology is significantly increasing.

Examples of a cryptocurrency include Bitcoin (BTC), Ethereum (ETH), Tether (USDT), Litecoin (LTC), and dash.

Unlike traditional currency issued by a government or a central bank, such cryptocurrencies are traded according to regulations set by original creators and are being distributed based on blockchain technology.

In the related art, a cryptocurrency is traded using a private key and a server configured to verify transaction information of the cryptocurrency and authorize the trading.

### SUMMARY

Example embodiments may provide automation technology for optimization trading (buy/sell) of a cryptocurrency.

Further, example embodiments may provide optimization trading information used for a user to buy/sell a cryptocurrency at the most favorable price (i.e., the lowest price for buying, and the highest prices for selling the cryptocurrency).

According to an aspect of an example embodiment, there is provided a cryptocurrency trading automation method including: receiving a request for converting a base coin held by a user into a target coin; determining a volume of the target coin to be traded with the base coin in at least one cryptocurrency market; and providing recommendation information related to trading of the target coin to an electronic device of the user based on the volume of the target coin.

The determining the volume of the target coin may include determining the volume of the target coin based on a market price for each pair of a market cryptocurrency of the at least one cryptocurrency market and a trading cryptocurrency tradable with the market cryptocurrency.

The determining the volume of the target coin may include: converting the base coin to a corresponding market coin for each market that allows the trading of the target coin; and determining a number of coins of the target coin tradable with the converted corresponding market coin.

The determining the volume of the target coin may include converting the base coin to a corresponding market coin for each market that allows the trading of the target coin; and determining a number of coins of the target coin tradable with a remaining market coin excluding a coin conversion fee from the converted corresponding market coin.

The at least one cryptocurrency market may include a plurality of cryptocurrency markets, and the base coin may be used as a market cryptocurrency of a base cryptocurrency market, among the plurality of cryptocurrency markets that allow the trading of the target coin. The determining the volume of the target coin may include: determining a number of coins of the target coin tradable with the base coin based on a number of coins of the base coin and a market price of the target coin in the base cryptocurrency market.

The determining the volume of the target coin may include: determining a number of coins of a corresponding market coin based on the number of coins of the base coin and a market price of the base coin in another cryptocurrency market that excludes the base cryptocurrency market from the plurality of cryptocurrency markets that allows the trading of the target coin; and determining the number of coins of the target coin tradable with the base coin based on the number of coins of the corresponding market coin and a market price of the target coin in the other cryptocurrency market.

The determining the volume of the target coin may include: determining a number of coins of a corresponding market coin based on the number of coins of the base coin and a market price of the corresponding market coin in the base cryptocurrency market; and determining the number of coins of the target coin tradable with the base coin based on the number of coins of the corresponding market coin and a market price of the target coin in another cryptocurrency market that excludes the base cryptocurrency market from the plurality of cryptocurrency markets that allow the trading of the target coin.

The providing the recommendation information may include displaying a recommend cryptocurrency market in which the volume of the target coin is largest among a plurality of cryptocurrency markets that allow the trading of the target coin to be distinguished from the plurality of cryptocurrency markets other than the recommended cryptocurrency market.

The providing the recommendation information may include providing ranking information in which a plurality of cryptocurrency markets that allow the trading of the target coin are sorted based on the volume of the target coin.

The providing the recommendation information may include providing an automatic trading function of processing the trading of the target coin in a recommend cryptocurrency market included in the recommendation information.

According to an aspect of another example embodiment, there is provided a non-transitory computer-readable record medium storing instructions that, when executed by a processor, cause the processor to perform the cryptocurrency trading automation method.

According to an aspect of another example embodiment, there is provided a computer system including: at least one memory configured to store computer-readable instructions; and at least one processor configured to execute the computer-readable instructions to: receive a request for converting a base coin held by a user into a target coin; determine a volume of the target coin to be traded with the base coin in at least one cryptocurrency market; and provide recommendation information related to trading of the target coin to an electronic device of the user based on the volume of the target coin.

The at least one processor may be further configured to determine the volume of the target coin based on a market price for each pair of a market cryptocurrency of the at least one cryptocurrency market and a trading cryptocurrency tradable with the market cryptocurrency.

The at least one processor may be further configured to: convert the base coin to a corresponding market coin for each market that allows the trading of the target coin; and determine a number of coins of the target coin tradable with the converted corresponding market coin.

The at least one processor may be further configured to: convert the base coin to a corresponding market coin for each market that allows the trading of the target coin; and determine a number of coins of the target coin tradable with a remaining market coin excluding a coin conversion fee from the converted corresponding market coin.

The at least one cryptocurrency market may include a plurality of cryptocurrency markets, and the base coin may be used as a market cryptocurrency of a base cryptocurrency market, among the plurality of cryptocurrency markets that allow the trading of the target coin. The at least one processor may be further configured to: determine a number of coins of the target coin tradable with the base coin based on a number of coins of the base coin and a market price of the target coin in the base cryptocurrency market.

The at least one processor may be further configured to: determine a number of coins of a corresponding market coin based on the number of coins of the base coin and a market price of the base coin in another cryptocurrency market that excludes the base cryptocurrency market from the plurality of cryptocurrency markets that allows the trading of the target coin; and determine the number of coins of the target coin tradable with the base coin based on the number of coins of the corresponding market coin and a market price of the target coin in the other cryptocurrency market.

The at least one processor may be further configured to: determine a number of coins of a corresponding market coin based on the number of coins of the base coin and a market price of the corresponding market coin in the base cryptocurrency market; and determine the number of coins of the target coin tradable with the base coin based on the number of coins of the corresponding market coin and a market price of the target coin in another cryptocurrency market that excludes the base cryptocurrency market from the plurality of cryptocurrency markets that allow the trading of the target coin.

The at least one processor may be further configured to: control a display to display a recommend cryptocurrency market in which the volume of the target coin is largest among a plurality of cryptocurrency markets that allow the trading of the target coin to be distinguished from the plurality of cryptocurrency markets other than the recommended cryptocurrency market; or control the display to provide ranking information in which the plurality of cryptocurrency markets that allow the trading of the target coin are sorted based on the volume of the target coin.

The at least one processor may be further configured to: provide an automatic trading function of processing the trading of the target coin in a recommended cryptocurrency market included in the recommendation information.

### BRIEF DESCRIPTION OF THE FIGURES

The above and/or other aspects will be more apparent by describing certain example embodiments, with reference to the accompanying drawings, in which:

FIG. 1 is a diagram illustrating an example of a network environment according to at least one example embodiment;

FIG. 2 is a diagram illustrating an example of an electronic device and a server according to at least one example embodiment;

FIG. 3 illustrates an example of a current coin status screen among service screens provided on a cryptocurrency exchange;

FIG. 4 is a diagram illustrating an example of components includable in a processor of a server according to at least one example embodiment;

FIG. 5 is a flowchart illustrating an example of a method performed by a server according to at least one example embodiment;

FIG. 6 is a flowchart illustrating an example of a process of calculating a volume of a target coin according to at least one example embodiment;

FIG. 7 illustrates an example of a volume of a target coin according to at least one example embodiment;

FIG. 8 illustrates an example of a service screen that provides optimization trading information according to at least one example embodiment;

FIGS. 9 and 10 illustrate other examples of a service screen that provides optimization trading information according to at least one example embodiment; and

FIG. 11 illustrates an example of a service screen that provides user trading details according to at least one example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

In the present disclosure, the term “base coin” may refer to virtual currency that a user holds as his/her asset, and the term “target coin” may refer to virtual currency that a user desires to buy. The term “market coin” may refer to virtual currency that is used in a cryptocurrency market, and the term “trading coin” may refer to virtual currency that can be traded with a market coin.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments are described with reference to the accompanying drawings.

The example embodiments relate to automation technology for optimization trading (buy/sell) of a cryptocurrency (hereinafter, also referred to as a coin)

The example embodiments including the disclosures herein may provide optimization trading information used for a user to buy/sell a coin at the best price, thereby maximizing a trading convenience and a user profit.

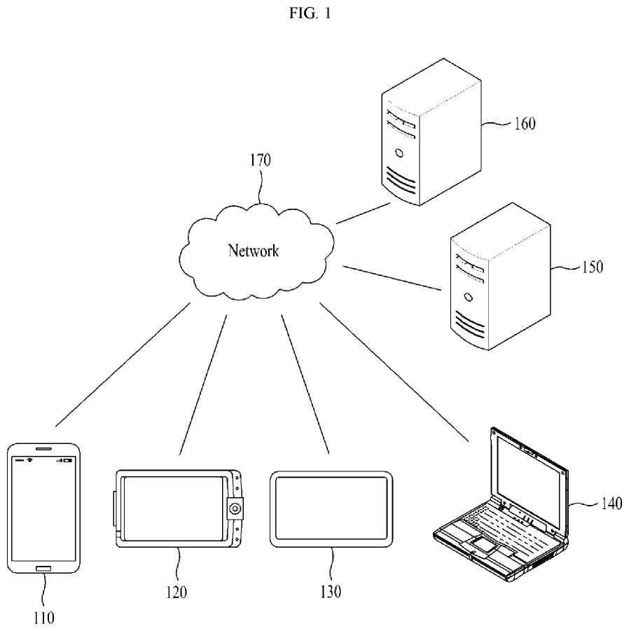

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a stationary terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and the like. For example, although FIG. 1 illustrates a shape of a smartphone as an example of the client device 210, the client device 210 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, the server 150 may provide, as the first service, a service (e.g., a cryptocurrency training service) intended by an application through the application as a computer program installed and executed on the plurality of electronic devices 110, 120, 130, and 140. As another example, the server 160 may provide, as the second service, a service that distributes a file for installing and executing the application to the plurality of electronic devices 110, 120, 130, and 140.

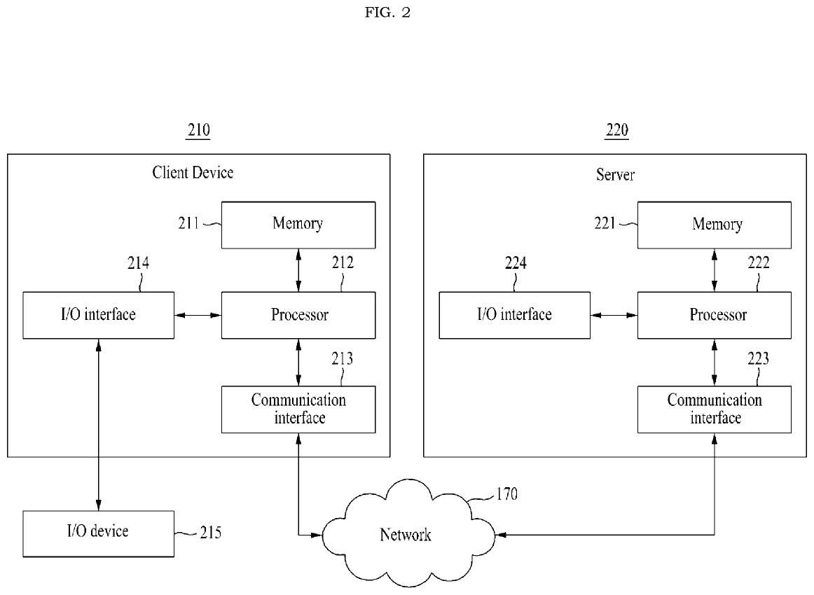

FIG. 2 is a block diagram illustrating an example of a client device and a server according to at least one example embodiment. A client device 210 shown in FIG. 2 may correspond to any one of the plurality of electronic devices 110, 120, 130, and 140 shown in FIG. 1, and a server 220 may correspond to the server 150 or the server 160 shown in FIG. 1.

Referring to FIG. 2, the client device 210 may include a memory 211, a processor 212, a communication interface 213, and an input/output (I/O) interface 214, and the server 220 may include a memory 221, a processor 222, a communication interface 223, and an I/O interface 224. The memory 211, 221 may include a permanent mass storage device, such as random access memory (RAM), a read only memory (ROM), a disk drive, a solid state drive (SSD), a flash memory, etc., as a non-transitory computer-readable record medium. The permanent mass storage device, such as ROM, SSD, flash memory, and disk drive, may be included in the client device 210 or the server 220 as a permanent storage device separate from the memory 211, 221. Also, an OS and at least one program code, for example, a code for a browser installed and executed on the client device 210 or an application installed and executed on the client device 210 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication interface 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication interface 213, 223 to the processor 212, 222. For example, the processor 212, 222 may be configured to execute received instructions in response to the program code stored in the storage device, such as the memory 211, 221.

The communication interface 213, 223 may provide a function for communication between the client device 210 and the server 220 over the network 170 and may provide a function for communication between the client device 210 and/or the server 220 with another electronic device, for example, the electronic device 120 or another server, for example, the server 160. For example, the processor 212 of the client device 210 may transfer a request created based on a program code stored in the storage device such as the memory 211, to the server 220 over the network 170 under control of the communication interface 213. The client device 210 may receive a control signal, an instruction or command, content, or data from the server 210, through the communication interface 213 of the client device 210. For example, a control signal, an instruction, content, a file, etc., of the server 220 received through the communication interface 213 may be transferred to the processor 212 or the memory 211, and content, a file, etc., may be stored in a storage medium, for example, the permanent storage device, further includable in the client device 210.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the client device 210. Also, the I/O interface 224 of the server 220 may be a device for interface with an apparatus for input or output that may be connected to the server 220 or included in the server 220. In detail, when the processor 212 of the client device 210 processes an instruction of a computer program loaded to the memory 211, content or a service screen configured based on data provided from the server 220 or the electronic device 120 may be displayed on the display through the I/O interface 214.

According to other example embodiments, the client device 210 and the server 220 may include a smaller or greater number of components than a number of components shown in FIG. 2. However, there is no need to clearly illustrate many components according to the related art. For example, the client device 210 may include at least a portion of the I/O apparatus 215, or may further include other components, for example, a transceiver, a global positioning system (GPS) module, a camera, a variety of sensors, a database (DB), and the like. In detail, if the client device 210 is a smartphone, the client device 210 may be configured to further include a variety of components, for example, an acceleration sensor, a gyro sensor, a camera module, various physical buttons, a button using a touch panel, an I/O port, a vibrator for vibration, etc., which are generally included in the smartphone.

Hereinafter, example embodiments of a method and system for optimization trading of a cryptocurrency are described in detail.

In general, a cryptocurrency exchange employs a scheme of using a specific cryptocurrency as a market cryptocurrency (a market coin, hereinafter, also referred to as a “market”) and thereby trading another cryptocurrency with a trading cryptocurrency (a trading coin, hereinafter, also referred to as a “coin”). That is, the cryptocurrency exchange allows buy/sell for each pair of a trading coin and a market coin [trading coin/market coin]. For example, if Ethereum (ETH) and Link (LN) are listed on the BTC market that allows trading using Bitcoin (BTC), trading may be allowed for each pair, for example, a pair of ETH coin and BTC coin [ETH/BTC] and a pair of LN coin and BTC coin [LN/BTC].

Since the cryptocurrency exchange allows trading for each pair of a market cryptocurrency (market coin) and a trading cryptocurrency (trading coin) (hereinafter, also, referred to as market-and-coin pair or market coin-and-trading coin pair), a user may not be allowed to exchange a trading coin by simply selecting the trading coin alone without selecting a market (or a market coin) in the related art. In particular, there has been no automation system that allows a user to buy or sell a coin at the best price in the related art.

Also, since a market price of even the same coin may differ for each market, the user needs to directly calculate a number of coins tradable for each market and to determine trading.

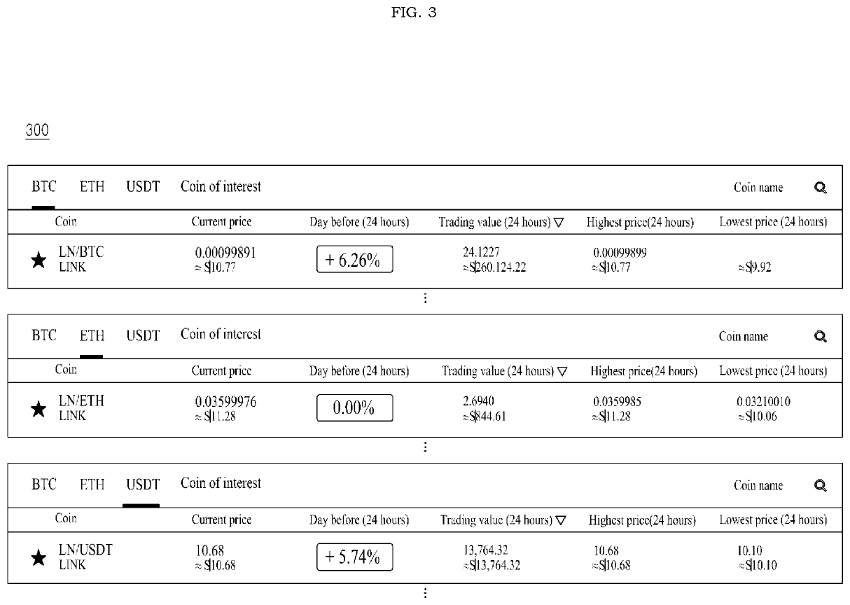

FIG. 3 illustrates an example of a current coin status screen 300 among service screens provided on a cryptocurrency exchange.

Referring to FIG. 3, if a user desires to buy LN coin (target coin) on the cryptocurrency exchange, the user selects a market through the current coin status screen 300 and verifies a market price of the LN coin for each market, for example, BTC, ETH, and Tether (USDT) markets. Referring to the current coin status screen 300, since a current price of the LN coin is lowest in the USDT market, the user may determine that it is most advantageous to buy the LN coin in the USDT market in order to buy a largest number of LN coins with the same investment.

However, although it is verifiable from the current coin status screen 300 that a corresponding market is most suitable to buy the LN coin, a type of coin held by the user as assets may differ and may need to be converted. Therefore, in the related art, the user himself may need to calculate whether it is advantageous even after a coin conversion fee is applied.

For example, although it is determined that it is advantageous to buy the LN coin in the USDT market at the present time, the user may hold only BTC coin (base coin). In this case, to buy the LN coin (target coin), the user may need to convert the BTC coin (base coin/trading coin) to the USDT coin (market coin). During this process, a coin version fee occurs.

That is, the user needs to calculate and evaluate a number of coins of the LN coin that may be purchased with an amount excluding the coin conversion fee by proceeding with a coin conversion process for each market based on a current market price of the LN coin that the user desires to purchase.

To overcome the above issue, the example embodiments may provide optimization trading information that allows the user to buy/sell coins at the most favorable price or to buy/sell a largest number of coins through an automation logic.

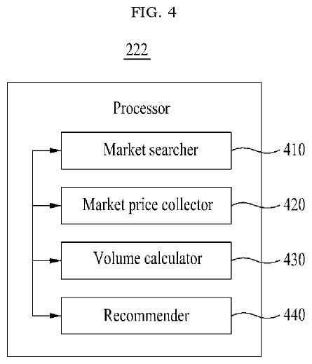

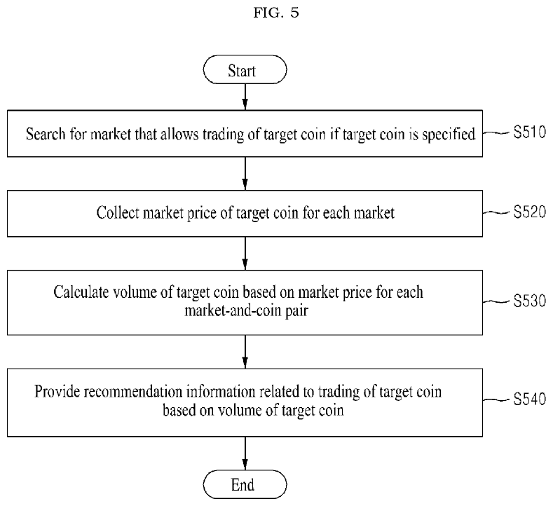

FIG. 4 is a diagram illustrating an example of components includable in a processor of a server according to at least one example embodiment, and FIG. 5 is a flowchart illustrating an example of a method performed by a server according to at least one example embodiment.

The server 220 according to the example embodiment serves as a platform that provides a cryptocurrency trading service. In particular, the server 220 may provide optimization trading information through an automation logic that calculates a number of coins tradable for each market.

Referring to FIG. 4, to perform a cryptocurrency trading automation method of FIG. 5, the processor 222 of the server 220 may include a market searcher 410, a market price collector 420, a volume calculator 430, and a recommender 440. Depending on example embodiments, the components of the processor 222 may be selectively included in or excluded from the processor 222. Also, depending on example embodiments, the components of the processor 222 may be separated or merged for representations of functions of the processor 222.

The processor 222 and the components of the processor 222 may control the server 220 to perform operations S510 to S540 included in the cryptocurrency trading automation method of FIG. 5. For example, the processor 222 and the components of the processor 222 may be configured to execute instructions according to a code of at least one program and a code of an OS included in the memory 221.

Here, the components of the processor 222 may be representations of different functions performed by the processor 222 in response to an instruction provided from a program code stored in the server 220. For example, the market searcher 410 may be used as a functional representation of the processor 222 that controls the server 220 to search for a market that allows trading of a specific coin in response to the instruction.

The processor 222 may read instructions from the memory 221 to control the server 220. The processor 222 may execute the instructions to perform operations S510 to S540. Operations S510 to S540 may be performed in the order different from the order illustrated in FIG. 5 and one or more of operations S510 to S540 may be omitted or an additional operation may be added.

Referring to FIG. 5, in operation S510, the processor 222 may set a target coin that a user of the client device 210 desires to purchase, according to a user request for converting a base coin that is held by the user into the target coin, and the market searcher 410 may search for a market that allows trading of the target coin. For example, in response to receiving a selection on a specific coin from the client device 210, the market searcher 410 may designate the selected specific coin as the target coin. As another example, the market searcher 410 may designate a coin of interest registered by the user of the client device 210 as the target coin. As described above, once the target coin is set or designated, the market searcher 410 may search for a market in which the target coin is listed as a tradable coin from among markets registered to a service platform of the server 220.

In operation S520, the market price collector 420 may collect a market price of the target coin being traded in a corresponding market for each market retrieved in operation S510. Also, the market price collector 420 may also collect a market price of the base coin included in assets of the user of the client device 210 being traded in a corresponding market for each trading allowed market. In one example embodiment, the client device 210 may allow the user to select a specific base coin used to purchase the target coin from among assets of the user and a number of coins of the selected specific base coin. Here, an automation logic aims at recommending a market in which the user is likely to purchase a largest number of coins of the target coin with the number of coins of the specific base coin selected by the user. Depending on example embodiments, unless the base coin used to purchase the target coin is selected, the automation logic may be executed with respect to all of base coins held by the user as assets. Here, the automation logic aims at recommending a market in which the user may purchase a largest number of coins of the target coin based on the same unit quantity, for each of the base coins. To this end, the market price collector 420 may collect a market price of the target coin and a market price of a corresponding base coin being traded in a corresponding market for each market. The processor 222 may store and maintain, in a database, related information required to provide the cryptocurrency trading service. The database may include market price information for each market-and-coin pair, and may be included in the server 220 as a storage device separate from the memory 221 or may be configured as separate system interactable with the server 220. The market price collector 420 may collect a market price for each market coin-and-trading coin pair by referring the target coin and the base coin to the database.

In operation S530, the volume calculator 430 may calculate a volume of the target coin tradable, that is, exchangeable in a corresponding market based on a market price of the target coin and a market price of the base coin being traded in a corresponding market for each market. That is, the volume calculator 430 may calculate the number of coins of the target coin tradable with the base coin based on the market price of each market coin-and-trading coin pair for each market. Here, for each market based on a market price for each market coin-and-trading coin pair, the volume calculator 430 may calculate the number of coins of the target coin that may be purchased based on a number of coins of a base coin selected by the user from among assets of the user or a unit quantity for each base coin corresponding to the assets of the user. A process of calculating the volume of the target coin for each market is further described below.

In operation S540, the recommender 440 may provide recommendation information related to the trading of the target coin to the user of the client device 210 based on the volume of the target coin for each market. For example, the recommender 440 may recommend at least one market based on the volume of the target coin for each market. For example, the recommender 440 may recommend a market in which the user may purchase a largest number of coins of the target coin with the base coin selected by the user among markets that allow the trading of the target coin. As another example, the recommender 440 may recommend a market in which the user may purchase a largest number of coins of the target coin based on a unit quantity of each base coin for each base coin included in assets of the user. Here, the recommender 440 may recommend a market with the base coin capable of purchasing a largest number of coins of the target coin based on the unit quantity. The recommendation information may be provided as ranking information about markets (and base coins) or may be provided by specifying a target to be recommended. The recommender 440 may provide recommendation information for the trading of the target coin and, in response to a request from the user of the client device 210, may also provide an automatic trading function of processing the trading (buy/sell) of the target coin to a market included in the recommendation information.

Although the description is made above based on the trading of buying the target coin, it applies alike to the trading of selling the target coin. The automation logic applies such that the user may acquire the largest number of coins with the final coin.

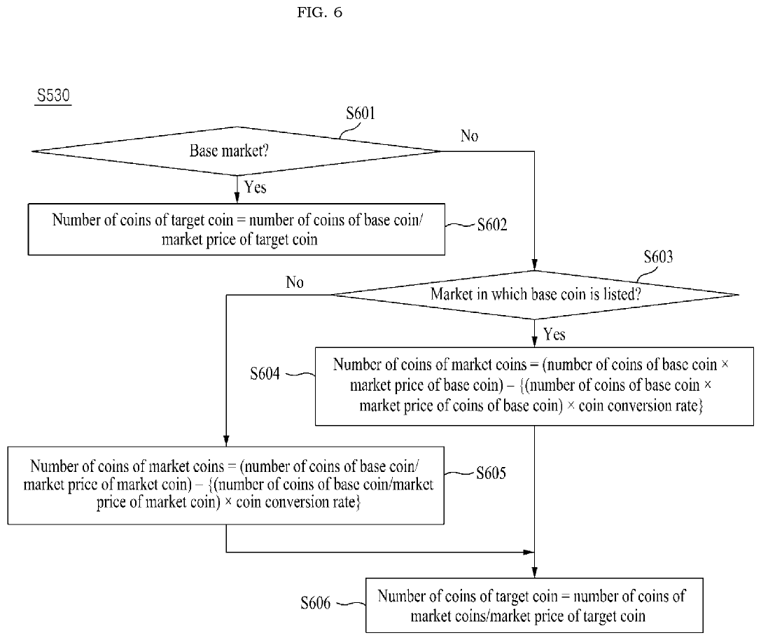

FIG. 6 is a flowchart illustrating an example of a process of calculating a volume of a target coin according to at least one example embodiment. A method of calculating the volume of the target coin of FIG. 6 may be included in operation S530 of FIG. 5.

Referring to FIG. 6, in operation S601, the volume calculator 430 may determine whether a market retrieved as a candidate market (i.e., a market in which the target coin is listed) allowing trading of the target coin corresponds to a market, that is, a base market that uses a base coin corresponding to assets of the user as a market cryptocurrency. If a plurality of markets is retrieved as candidate markets that allow the trading of the target coin, the volume calculator 430 may calculate the volume of the target coin for each candidate market according to the method of calculating the volume of the target coin of FIG. 6.

In operation S602, in the case of the base market that uses the base coin as the market cryptocurrency, the volume calculator 430 may calculate a number of coins of the target coin tradable with the base coin based on a market price of the target coin in the corresponding base market. For example, the volume calculator 430 may calculate the number of coins of the target coin tradable with the base coin in the base market according to the following Equation 1.

Number of coins of target coin=number of coins of base coin/market price of target coin [Equation 1]

In operation S603, in the case of another market excluding the base market that uses the base coin as the market cryptocurrency, the volume calculator 430 may verify whether the base coin is present among coins listed in the corresponding market.

In operation S604, if a corresponding candidate market that allows trading of the target coin is a market in which the base coin is listed, the volume calculator 430 may calculate a number of coins of a corresponding market coin tradable with the base coin based on a market price of the base coin in the corresponding market. For example, the volume calculator 430 may calculate the number of coins of the market coin tradable with the base coin in the market in which the base coin is listed according to the following Equation 2.

Number of coins of market coin=(number of coins of base coin×market price of base coin)−coin conversion fee [Equation 2]

Here, the coin conversion fee may be defined as (number of coins of base coin× market price of base coin)×coin conversion rate (e.g., 0.001) and may also be a predetermined amount of the market coin.

For example, if the base coin BTC is listed in the USDT market at a time of converting the base coin BTC to the target coin LN in the USDT market, the volume calculator 430 may initially convert the base coin BTC to the market coin USDT. Here, a number of coins of the market coin USDT convertible from the base coin BTC may be calculated according to {(number of coins of base coin BTC)×(market price of base coin BTC in USDT market)−number of coins of USDT corresponding to coin conversion fee}.

In operation S605, if the candidate market that allows the trading of the target coin is a market in which the base coin is not listed, the volume calculator 430 may calculate the number of coins of the market coin tradable with the base coin based on the market price of the corresponding market coin in the base market. For example, if the base coin is not listed in the corresponding market, the volume calculator 430 may calculate the number of coins of the market coin tradable with the base coin based on the market price of the corresponding market coin according to the following Equation 3.

Number of coins of market coin=(number of coins of base coin/market price of market coin)−coin conversion fee [Equation 3]

Here, the coin conversion fee may be defined as (number of coins of base coin/market price of market coin)×coin conversion rate (e.g., 0.001).

For example, if the base coin BTC is not listed in the ETH market at a time of converting the base coin BTC to the target coin LN in the ETH market, the volume calculator 430 may initially convert the base coin BTC to the market coin ETH in the BTC market. Here, a number of coins of the market coin ETH convertible from the base coin BTC may be calculated according to {(number of coins of base coin BTC)/(market price of market coin ETH in BTC market)−number of coins of ETH corresponding to coin conversion fee}.

In operation S606, if the candidate market that allows the trading of the target market is another market aside from the base market, the volume calculator 430 may calculate a number of coins of target coin tradable with the base coin based on the number of coins of the market coin calculated in operation S604 or S605 and the market price of the market coin in the corresponding market. For example, the volume calculator 430 may calculate the number of coins of the target coin tradable with the base coin in another market aside from the base market, according to the following Equation 4.

Number of coins of target coin=number of coins of market coin/market price of target coin [Equation 4]

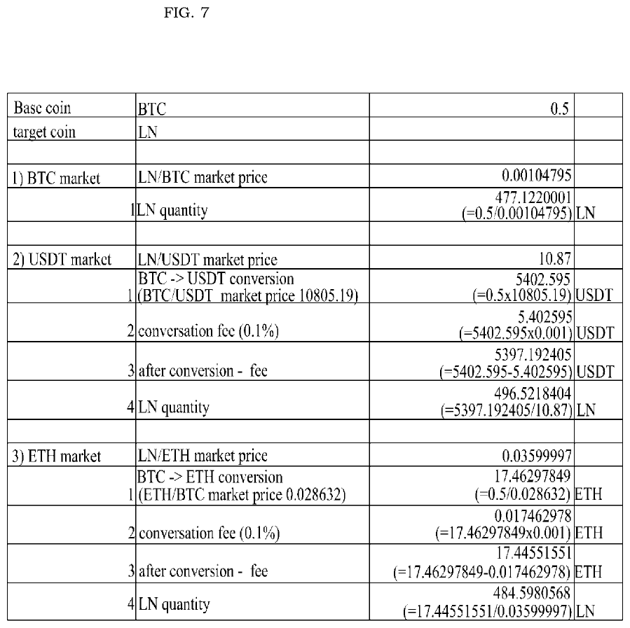

FIG. 7 illustrates an example of a volume of a target coin according to at least one example embodiment. FIG. 7 illustrates a process of calculating a number of coins of LN coin that may be purchased in each market with 0.5 BTC coin.

FIG. 7 relates to calculating the number of coins of LN coin tradable with 0.5 BTC coin with respect to all of the markets in which the target coin LN is listed. Referring to FIG. 7, 1) in the case of the BTC market that uses the base coin BTC as a market cryptocurrency, the number of coins of LN coin tradable in the BTC market may be calculated by dividing 0.5 BTC coin by the market price of the LN coin in the BTC market (e.g., 1LN=0.00104795BTC).

2) In the case of the USDT market that is one of markets in which the target coin LN is listed, the number of coins of LN coin tradable, the number of coins of the LN coin tradable in the USDT market may be calculated by i) converting the base coin BTC to the market coin USDT (e.g., if the base coin BTC is listed in the USDT market, BTC 0.5 BTC X 10805.19 USDT/MTC), ii) calculating a coin conversion fee, iii) calculating the USDT coin excluding the calculated coin conversion fee (e.g., 5397.192405 USDT), and iv) dividing the same by the market price of LN in the USDT market {e.g., 5397.192405 USDT/(10.87 USDT/1 LN)}.

3) In the case of the ETH market that is another market among the markets in which the target coin LN is listed, the number of coins of LN coin tradable in the ETH market may be calculated by i) converting the base coin BTC to the market coin ETH {e.g., if the base coin BTC is not listed in the ETH market, 0.5 BTC/(0.028632 BTC/1 ETH) using the market price of the market coin ETH in the BTC market}, ii) calculating a coin conversion fee, iii) calculating the ETH coin excluding the calculated coin conversion fee (e.g., 17.44551551 ETH), and iv) by dividing the same by the market price of LN in the ETH market (e.g., 17.44551551 ETH/(0.03599997 ETH/1 LN)}.

In the case of converting a base coin to a market coin in a specific market, if the base coin is listed in the specific market, a method of multiplying a number of coins of the base coin by a market price of the base coin in the corresponding market may apply. Otherwise, a method of dividing the number of coins of the base coin by a market price of a corresponding market coin may apply. For example, if the BTC coin is listed in the USTDT market at a time of coin conversion, the BTC coin is converted to the USDT coin through a method of multiplying the number of coins of the BTC coin by the market price of the BTC coin in the USDT market. If the BTC coin is not listed in the ETH market, the BTC coin is converted to the ETH coin through a method of dividing the number of coins of the BTC coin by the market price of the ETH coin in the BTC market.

Also, when referring to a market price of coin for each market, a highest price of buy order and a lowest price of sell order in order book of a unit time (e.g., 24 hours) may be used as a market price for calculation based on a probability that exchange and signing may not be made at a current market price.

If the target coin LN is listed in the BTC market, the USDT market, and the ETH market, a number of coins of LN coin that may be purchased in each market with 0.5 BTC may differ for each market. In the example of FIG. 7, the USDT market is a market in which the user may purchase a largest number of coins of LN coin with the same quantity of BTC coin.

The recommender 440 may select a market in which the user may purchase the largest number of coins of the target coin LN with the base coin from among markets in which the target coin LN is listed and may provide the selected market to the user as recommendation information.

In the existing art, trading is possible based on only a pair of [base/target] or [target/base] as a pair of [coin/market]. The example embodiments may repeat coin conversion and may recommend further advantageous trading information to the user using a logic, such as, for example, [base/other_1]→ . . . →[other_m/other_n]→ . . . →[other1/target].

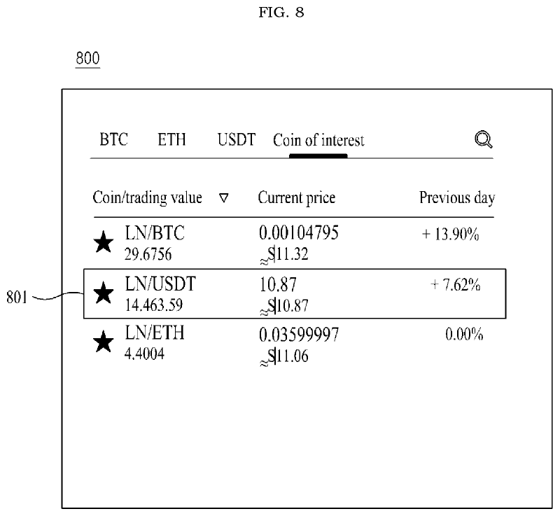

FIG. 8 illustrates an example of a service screen that provides optimization trading information according to at least one example embodiment.

Referring to FIG. 8, if LN coin is registered as a coin of interest that is a target coin of the user of the client device 210, the recommender 440 may provide trading information including a market price for each pair of the LN coin and market (BTC, USDT, ETH) through a service screen 800 related to the coin of interest. Here, the recommender 440 may display a market 801 in which the user of the client device 210 may purchase a largest number of coins of LN coin with the asset coin held by the user of the client device 210 to be distinguished from other markets. In addition to specifying and displaying the market 801 in which the user may purchase the largest number of coins of LN coin, the recommender 440 may sort coin-and-market pairs in descending order of a largest number of tradable coins of LN coin and may provide optimization trading information as ranking information. Further, if a plurality of coins of interest that the user desires to purchase is registered, the recommender 440 may recommend a market in which the user may purchase a largest number of coins with a corresponding asset coin of the user with respect to each registered coin of interest. Also, if the user holds various types of asset coins, the recommender 440 may recommend an asset coin with which the user may purchase a largest number of coins of LN coin based on the same unit quantity among the asset coins of the user, with a corresponding market.

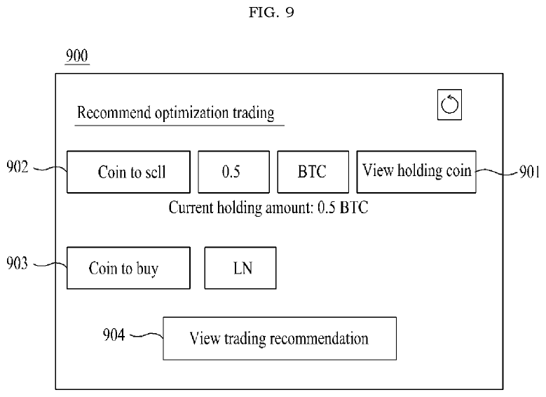

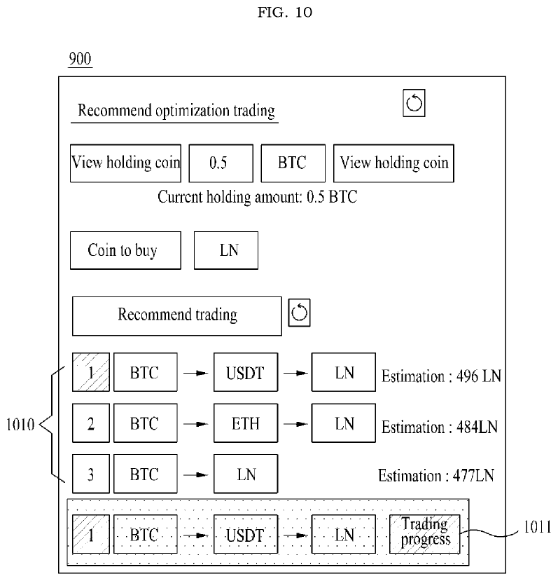

FIGS. 9 and 10 illustrate other examples of a service screen that provides optimization trading information according to at least one example embodiment.

FIG. 9 illustrates an example of an optimization trading screen 900. Referring to FIG. 9, the optimization trading screen 900 may include a “View held coin” user interface (UI) 901 for verifying a coin held by the user, a “Coin to sell” UI 901 for selecting or inputting a base coin and a number of coins to be traded, a “Coin to buy” UI 903 for selecting or inputting a target coin, and a “View trading recommendation” UI 904 for requesting optimization trading information.

The user may verify assets held by the user through the optimization trading screen 900, may select a base coin that the user desires to sell and a number of coins of the base coin, and may also select a target coin that the user desires to purchase.

For example, if the user of the client device 210 selects 0.5 BTC coin as the base coin and selects the LN coin as the target coin on the optimization trading screen 900 and then selects the “View trading recommendation” UI 904, the recommender 440 may provide a recommendation list 1010 for a trading route through which the user is capable of purchasing the LN coin. The recommendation list 1010 may include optimization trading information in which market pairs for the LN coin are sorted in descending order of an estimated largest number of coins of LN coin capable of being purchased. Although the user does not directly perform calculation, the user may verify the estimated number of coins of LN coin the user is capable of purchasing with 0.5 BTC coin for each market pair and may verify a market pair that allows the user to purchase the largest number of coins of LN coin through the recommendation list 1010.

If the user selects a specific market pair from the recommendation list 1010 displayed on the optimization trading screen 900, a “Trading progress” UI 1011 for processing trading of the LN coin may be activated for the selected market pair. If the user selects the specific market pair from the recommendation list 1010 and then inputs the “Trading progress” UI 1011, the user may immediately process the trading (buy) of purchasing the LN coin with the 0.5 BTC coin through the corresponding market.

In addition to the aforementioned interface for optimization trading according to a user selection on the base coin and the target coin, an interface capable of verifying user trading details may be provided.

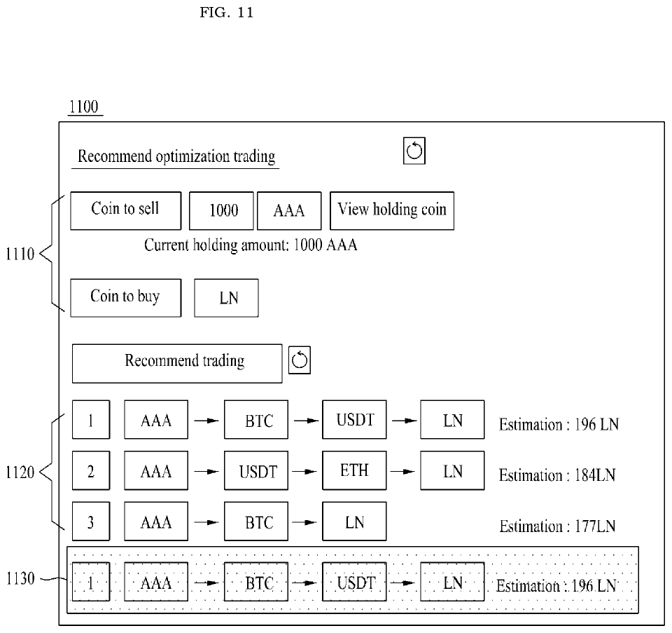

FIG. 11 illustrates an example of a user trading details screen 1100. Referring to FIG. 11, in response to receiving a request for trading details from the user of the client device 210, the recommender 440 may provide coin selection details 1110 about a base coin and a target coin selected for trading by the user, recommendation details 1120 provided as optimization trading information about the base coin and the target coin selected by the user, and trading details 1130 actually traded with the base coin and the target coin selected by the user through the user trading details screen 1100. The base coin may not be one of market coins and a coin aside from the market coin may be included in a trading route through which the base coin is converted to the target coin.

An optimization trading recommendation screen is not limited to the aforementioned service screens and may provide optimization trading information related to trading of the target coin through various access routes and interfaces.

According to example embodiments, although the user does not specify a market, it is possible to automatically calculate a number of coins the user is capable of buying/selling with an access coin of the user for each market and to recommend optimization trading information most beneficial to the user and to automate optimization trading for coin.

The apparatuses described herein may be implemented using hardware components, software components, and/or a combination thereof. For example, a processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the example embodiments may be recorded in non-transitory computer-readable storage media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable storage media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A cryptocurrency trading automation method comprising:
receiving a request for converting a base coin held by a user into a target coin;
determining a volume of the target coin to be traded with the base coin in at least one cryptocurrency market; and
providing recommendation information related to trading of the target coin to an electronic device of the user based on the volume of the target coin.

2. The cryptocurrency trading automation method of claim 1, wherein the determining the volume of the target coin comprises determining the volume of the target coin based on a market price for each pair of a market cryptocurrency of the at least one cryptocurrency market and a trading cryptocurrency tradable with the market cryptocurrency.

3. The cryptocurrency trading automation method of claim 1, wherein the determining the volume of the target coin comprises:
converting the base coin to a corresponding market coin for each market that allows the trading of the target coin; and
determining a number of coins of the target coin tradable with the converted corresponding market coin.

4. The cryptocurrency trading automation method of claim 1, wherein the determining the volume of the target coin comprises:
converting the base coin to a corresponding market coin for each market that allows the trading of the target coin; and
determining a number of coins of the target coin tradable with a remaining market coin excluding a coin conversion fee from the converted corresponding market coin.

5. The cryptocurrency trading automation method of claim 1, wherein the at least one cryptocurrency market comprises a plurality of cryptocurrency markets, and the base coin is used as a market cryptocurrency of a base cryptocurrency market, among the plurality of cryptocurrency markets that allow the trading of the target coin, and
wherein the determining the volume of the target coin comprises determining a number of coins of the target coin tradable with the base coin based on a number of coins of the base coin and a market price of the target coin in the base cryptocurrency market.

6. The cryptocurrency trading automation method of claim 5, wherein the determining the volume of the target coin comprises:
determining a number of coins of a corresponding market coin based on the number of coins of the base coin and a market price of the base coin in another cryptocurrency market that excludes the base cryptocurrency market from the plurality of cryptocurrency markets that allows the trading of the target coin; and
determining the number of coins of the target coin tradable with the base coin based on the number of coins of the corresponding market coin and a market price of the target coin in the other cryptocurrency market.

7. The cryptocurrency trading automation method of claim 5, wherein the determining the volume of the target coin comprises:
determining a number of coins of a corresponding market coin based on the number of coins of the base coin and a market price of the corresponding market coin in the base cryptocurrency market; and
determining the number of coins of the target coin tradable with the base coin based on the number of coins of the corresponding market coin and a market price of the target coin in another cryptocurrency market that excludes the base cryptocurrency market from the plurality of cryptocurrency markets that allow the trading of the target coin.

8. The cryptocurrency trading automation method of claim 1, wherein the providing the recommendation information comprises displaying a recommend cryptocurrency market in which the volume of the target coin is largest among a plurality of cryptocurrency markets that allow the trading of the target coin to be distinguished from the plurality of cryptocurrency markets other than the recommended cryptocurrency market.

9. The cryptocurrency trading automation method of claim 1, wherein the providing the recommendation information comprises providing ranking information in which a plurality of cryptocurrency markets that allow the trading of the target coin are sorted based on the volume of the target coin.

10. The cryptocurrency trading automation method of claim 1, wherein the providing the recommendation information comprises providing an automatic trading function of processing the trading of the target coin in a recommend cryptocurrency market included in the recommendation information.

11. A non-transitory computer-readable record medium storing instructions that, when executed by a processor, cause the processor to perform the cryptocurrency trading automation method of claim 1.

12. A computer system comprising:
at least one memory configured to store computer-readable instructions; and
at least one processor configured to execute the computer-readable instructions to:
receive a request for converting a base coin held by a user into a target coin;
determine a volume of the target coin to be traded with the base coin in at least one cryptocurrency market; and
provide recommendation information related to trading of the target coin to an electronic device of the user based on the volume of the target coin.

13. The computer system of claim 12, wherein the at least one processor is further configured to determine the volume of the target coin based on a market price for each pair of a market cryptocurrency of the at least one cryptocurrency market and a trading cryptocurrency tradable with the market cryptocurrency.

14. The computer system of claim 12, wherein the at least one processor is further configured to:
convert the base coin to a corresponding market coin for each market that allows the trading of the target coin; and
determine a number of coins of the target coin tradable with the converted corresponding market coin.

15. The computer system of claim 12, wherein the at least one processor is further configured to:
convert the base coin to a corresponding market coin for each market that allows the trading of the target coin; and
determine a number of coins of the target coin tradable with a remaining market coin excluding a coin conversion fee from the converted corresponding market coin.

16. The computer system of claim 12, wherein the at least one cryptocurrency market comprises a plurality of cryptocurrency markets, and the base coin is used as a market cryptocurrency of a base cryptocurrency market, among the plurality of cryptocurrency markets that allow the trading of the target coin, and
wherein the at least one processor is further configured to determine a number of coins of the target coin tradable with the base coin based on a number of coins of the base coin and a market price of the target coin in the base cryptocurrency market.

17. The computer system of claim 16, wherein the at least one processor is further configured to:
determine a number of coins of a corresponding market coin based on the number of coins of the base coin and a market price of the base coin in another cryptocurrency market that excludes the base cryptocurrency market from the plurality of cryptocurrency markets that allows the trading of the target coin; and
determine the number of coins of the target coin tradable with the base coin based on the number of coins of the corresponding market coin and a market price of the target coin in the other cryptocurrency market.

18. The computer system of claim 16, wherein the at least one processor is further configured to:
determine a number of coins of a corresponding market coin based on the number of coins of the base coin and a market price of the corresponding market coin in the base cryptocurrency market; and
determine the number of coins of the target coin tradable with the base coin based on the number of coins of the corresponding market coin and a market price of the target coin in another cryptocurrency market that excludes the base cryptocurrency market from the plurality of cryptocurrency markets that allow the trading of the target coin.

19. The computer system of claim 12, wherein the at least one processor is further configured to:
control a display to display a recommend cryptocurrency market in which the volume of the target coin is largest among a plurality of cryptocurrency markets that allow the trading of the target coin to be distinguished from the plurality of cryptocurrency markets other than the recommended cryptocurrency market; or
control the display to provide ranking information in which the plurality of cryptocurrency markets that allow the trading of the target coin are sorted based on the volume of the target coin.

20. The computer system of claim 12, wherein the at least one processor is further configured to:
provide an automatic trading function of processing the trading of the target coin in a recommended cryptocurrency market included in the recommendation information.
